(19) United States
(12) Patent Application Publication
(10) Pub. No.: US 2017/0005338 A1
(43) Pub. Date: Jan. 5, 2017

(54) ELECTRICAL STORAGE BATTERIES

(71) Applicant: Giga Amps UK Limited, Wark Hexam (GB)

(72) Inventor: Neill HUMAN, Strand (ZA)

(21) Appl. No.: 15/198,296

(22) Filed: Jun. 30, 2016

(30) Foreign Application Priority Data
Jul. 1, 2015 (GB) 1511577.7
Sep. 18, 2015 (GB) 1516602.8

(51) Int. Cl. H01M 4/62; H01M 4/04

(52) U.S. Cl. CPC H01M 4/628; H01M 4/0485

(57) ABSTRACT

Electrical storage batteries and methods of making electrical storage batteries are disclosed. The electrodes (122) of the batteries each comprise a hollow core (124) of electrically conductive material which is sheathed in lead to protect the core from corrosion by the battery acid. Electrochemically active positive material or electrochemically active negative material (116) is cast onto the core. The hollow core permits fluid, gas or liquid, to be fed through the core to prevent excessive increases in battery temperature during charging and discharging.

### RELATED APPLICATIONS

This application claims the benefit of priority of United Kingdom Patent Applications Nos. 1511577.7 filed Jul. 1, 2015, and 1516602.8 filed Sep. 18, 2015. The contents of the above applications are incorporated herein by reference in their entirety.

### FIELD AND BACKGROUND OF THE INVENTION

This invention relates to electrical storage batteries, to the manufacture of electrical storage batteries and to components thereof.

The market for electrical storage batteries in the renewable energy and electricity utility sector has recently seen a significant increase. This has been driven by the increase in renewable energy technologies in the past decade and the changing consumer market that requires more electricity to power its ever increasing demand for electronic devices.

This, together with recent advances in electric vehicle technologies, will still further increase the demand for utility scale electricity supply especially as electrical charging stations for these electrical vehicles will form an integral part of their viability.

There, however, exists a disparity between supply and demand for electricity especially where renewable generation sources are concerned. The sources are inherently intermittent by nature, with usable sunlight only available a few hours a day, changing with season and subject to weather conditions such as cloud cover and shading from surrounding structures.

Wind as a source of energy is also subject to the vagaries of nature. If the wind is insufficiently strong, little power is generated. If the wind is too strong the turbines have to be shut down to protect the blades and tower from potential damage. Because of their visual impact on the environment many wind farms are situated in remote areas.

Coal, oil and nuclear power stations are controlled by matching generating capacity to demand. Such control is difficult with renewable energy sources as power may not be available due to sun and wind conditions when demand is high. The variable input from renewal sources makes management of the grid difficult.

In order to align supply and demand of electricity, and accommodate the rapid growth of demand, utility scale electricity storage solutions to mitigate the intermittent nature of renewable energy sources, and the disparity between supply and demand, become a necessity.

The lead acid battery has since its inception been the most used form of power storage device, because of its low cost per unit of energy delivered and its proven track record within all sectors and across multiple applications. There are, however, limitations on how much energy can be stored in a lead acid battery at a certain cost per unit when it is manufactured by what has become the conventional method.

These limitations typically include the effect of heat on the operation of the battery when too many plates are included in one cell and a concentration of heat occurs between the plates at the centre of the battery. There is little available surface area for heat transfer to atmosphere and overheating can occur. There are also problems with the durability of the plates of current batteries as these are not manufactured for utility scale operation but for industrial application.

There is also increasing competition for lead acid batteries from higher cost chemistries such as Lithium-ion based batteries as their cost structures improve and increase their viability for utility scale storage.

In order to achieve utility scale storage with conventional industrial batteries, more cells have to be connected in series and parallel to achieve the high rates of charge, large amounts of energy storage and high rates of discharge required. It is well known that adding more batteries to a series or parallel connection can significantly reduce the life expectancy of the batteries and risk of failure as one faulty cell in a battery can eventually unbalance, drain and destroy the entire battery bank through internal short circuits. The higher the number of individual batteries in a battery bank, the greater the requirement for battery management becomes and the more difficult it is to keep the individual batteries balanced and operating at ideal capacity. The risk of variations between batteries increases as the storage capacity gets greater.

The standard method of manufacturing a plate for a lead acid battery comprises melting lead ingots in a lead furnace and then using the molten lead to produce a relatively flimsy grid by continuous casting, moulding or stamping, or a combination of these methods. Industrial scale battery manufacturing uses casting, where a book mould is filled with molten lead, or injection moulding to create the lead grid structure.

The conventional manufacturing processes involve maintaining lead molten during the initial part of the production procedure. Subsequently the lead is cooled in a mould and the grids produced are released from the mould. The maintenance of lead in a molten state adds significantly to the cost of manufacturing

These processes also involve cutting away excess lead at various stages in the grid manufacturing process, resulting in waste lead that has to be melted again, adding to the cost of the process. Constituents such as calcium are added to the molten lead to provide more rigidity to the grids which would otherwise be too flimsy to handle during manufacturing and, in addition, flimsy pure lead grid plates tend to buckle easily in use and can cause internal short circuits. The added constituents not only increase the internal resistance of the battery but also reduce its life expectancy as these plates tend to be more prone to corrosion than pure lead plates.

In order to streamline manufacturing and reduce downtime due to mould changes and machine cleaning, manufacturers use dual purpose moulds that are capable of moulding various lengths and sizes of grids simultaneously. This, however, can also result in waste lead as the production from one side of the mould may not be used when a specific grid production run is desired, again resulting in re-melting of lead.

The highly automated nature of battery manufacturing also results in further losses as the tolerances of the grids fed to the production machines cannot vary by a large degree. Hence some of the lead grids may have to be removed from the manufacturing process. The removed grids are re-melted and the lead recycled.

The manufacturing processes as described above and as found in operation today, require a significant amount of specialised equipment to melt lead ingots and get the lead into the desired grid form before it goes on to be pasted electrochemically using active material. This represents a large capital investment with highly skilled labour requirements and large amounts of electricity and floor space for its operation.

Once the lead grid has the desired form, it is passed through a belt pasting machine where active material supplied from an oxide mixer through a hopper is adhered to the lead grid. The electrochemically active material fills the openings in the grid thereby creating a battery plate. If the grid is “overpasted” there is a layer of material on each side of the grid as well as “pellets” in the openings. Although this may be desirable to achieve higher storage capacity, the active material adhered to the outside of each side of the plate, tend to spall off more easily, resulting in these grids eventually only being “flush” pasted.

An alternative method of pasting comprises filling the active material into a sachet containing a moulded electrode with spines. There is, however, a limitation as this process is used for the positive plates only and the negative plates are manufactured by the methods described above. Other limitations are how thick these spines can be and how much active material can surround them within the sachet.

The standard method of manufacturing lead grids and pasting them with active material has associated trade-offs that influence the efficiency of the grid. Each electrode grid fulfils multiple purposes. Its primary function is to act as the anode and/or cathode and to conduct electricity. However, it also functions as the substrate to which active material needs to adhere for the battery to function. In addition the grid also provides structural rigidity to the pasted plate so that it does not buckle, bend or deform and shed active material.

It is desirable to have the optimal volume of active material in the immediate proximity of the grid. The storage capacity of a lead acid battery is proportional to the volume of chemically active material and available electrolyte that can react with each other. It is also proportional to the surface area of the grid that is in contact with the active material and electrolyte and conducts the electrons that are released from the respective reactions. The volume of material that can successfully be carried by a conventional grid is limited, and hence the storage capacity of a conventional lead acid battery is likewise limited.

In use batteries are subjected to charge and discharge cycles. Over time the paste spalls off the grid as a result of incomplete dissolution and precipitation reactions. The tendency for the paste to disintegrate over time is exacerbated if the battery overheats, and particularly if the overheating is such as to corrode and buckle the grid. According to the Arrhenius equation, which predicts the temperature dependence of reactions, typical battery life will be halved for every 8.3 to 10 degrees Celsius of operation above the temperature specified for operation depending on battery type. This relates to the incomplete dissolution and precipitation of active material and the consequential shedding of active material, but also to the rate of grid corrosion that ultimately leads to capacity degradation and battery failure.

Batteries in use are subject to various sources of heat including ambient temperatures and internally generated temperatures. Internal battery temperature is influenced by the heat associated with the chemical reactions during charging. There are ohmic losses due to resistance of the electrode as a conductor and as a result of water decomposition once the gassing voltage has been reached close to full state of charge. Ohmic heat and heat generated by water decomposition may be significant, especially under frequent operation and may easily increase battery temperature to over the 8.3 degrees Celsius above specified temperature.

The present invention provides a fundamentally different approach to the construction of electrical storage batteries and to their method of manufacture order to overcome the deficiencies of conventionally manufactured batteries.

### SUMMARY OF THE INVENTION

According to a first aspect of the present invention there is provided an electrical storage battery electrode comprising an electrically conductive elongate metal core which is sheathed in lead to protect the core from corrosion by battery acid.

Said core can be tubular and preferably comprises a copper or aluminium tube.

To increase the external surface area of the core it can have external fins or the outer surface of the core can be of non-circular configuration.

According to a second aspect of the present invention there is provided an electrical storage battery an electrode of which is in the form of a tube which is open at its upper and lower ends.

Said electrode of the battery can comprise an elongate metal core which is sheathed in lead to protect the core from corrosion by battery acid. The battery can have positive electrodes and negative electrodes each of which is in the form of a tube which is open at its upper and lower ends.

According to a third aspect of the present invention there is provided a method of manufacturing a cast battery plate for an electrical storage battery which comprises placing an electrically conductive electrode in a mould, feeding a slurry of electrochemically active material into the mould so as embed the greater part of the electrode in the material whilst leaving a portion protruding from the material so as to provide a terminal post, and removing the electrode from the mould after the active material has dried sufficiently to be self-supporting.

According to a fourth aspect of the present inventions there is provided a method of manufacturing a cast positive plate for an electrical storage battery which comprises placing an electrically conductive electrode in a mould the walling of which is porous, feeding a slurry of electrochemically active positive material into the mould so as to embed the greater part of the electrode in the active material whilst leaving a portion protruding from the material to form a terminal post.

According to a fifth aspect of the present invention there is provided an electrical storage battery comprising a first set of cast plates having positive electrochemically active material and a second set of cast plates having electrochemically active negative material, the sets of plates being manufactured as defined in the two preceding paragraphs and being immersed in battery acid.

Said elements are preferable elongate tubes which protrude from the active material in both directions so as to provide flow paths through the battery.

Each electrode preferably comprises an electrically conductive metal core which is lead coated.

According to a sixth aspect of the present invention there is provided a method of manufacturing a battery which comprises placing electrically conductive electrodes and void formers in a casing, feeding electrochemically active material into the casing to embed the formers and the electrodes in the material, removing the void formers from the material and inserting battery plates manufactured as defined above into the voids that remain upon removal of the void formers.

According to a seventh aspect of the present invention there is provided an electrical storage battery comprising a vertically elongate casing, a plurality of spaced apart elongate plates extending vertically within the casing, each plate comprising an electrically conductive core which is sheathed in lead to protect it from corrosion by the battery acid and a body of electrochemically active material moulded onto the core, the space in the casing around the electrodes being filled with electrochemically active material of opposite polarity, electrically conductive elements protruding from the active material which fills said space and porous separators between the active material of the plates and the active material filling said space.

Said electrodes can be arranged in one or more circular arrays. If is also possible for said plates to be arranged in one or more circular arrays with arrays of plates alternating with arrays of elements.

Preferably the moulded material of the plates is electrochemically active positive material.

According to an eighth aspect of the present invention there is provided a method of manufacturing an electrical storage battery which comprises manufacturing plates by moulding electrochemically active material onto electrically conductive cores which are sheathed in lead, placing elongate void formers and elongate electrically conductive elements in an elongate casing, filling the space around said void formers and elements with electrochemically active material of opposite polarity to that of the plates, removing the void formers to provide voids and inserting said plates into the voids, there being porous separators between the plates and the active material filling said space.

Electrochemically active materials of different composition can be fed into the casing to provide layers having different characteristics.

The upper ends of said cores and said elements can be threaded and bus bars with holes through which said upper ends project used to connect cores to one another and elements to one another, nuts screwed onto said upper ends clamping the bars to the respective cores and elements.

According to a ninth aspect of the present invention there is provided a battery which comprises a casing which has in it a body of electrochemically active material with electrically conductive elements embedded in said body of material but each having a part thereof protruding from the body, and plates each comprising a lead sheathed electrically conductive metal core with electrochemically active material cast onto it, the cores protruding from the cast active material, said plates being in voids provided therefor in said body of material, being separated from said body by porous separators, and being removable from said voids.

Preferably the cast material is electrochemically positive and the body of material is electrochemically negative.

According to a tenth aspect of the present invention there is provided a method of manufacturing an electrical storage battery which method comprises creating a first set of cavities for receiving electrochemically active negative material, creating a second set of intervening cavities for receiving electrochemically active positive material, providing electrically conductive electrode structures in said cavities, introducing said negative active material into the cavities of the first set of cavities and introducing positive active material into the cavities of the second set of cavities.

This method can further comprise creating the cavities of the second set by means of walling, introducing positive active material into said cavities of the second set, removing the walling to leave spaces which constitute the cavities of the first set of cavities, and filling the cavities of the first set with negative active material.

Alternatively this method can further comprise creating a first cavity of the second set by means of walling and inserting an electrode structure into this first cavity, introducing positive active material into said first cavity, moving said walling to create a first cavity of the first set and inserting an electrode structure into this cavity, introducing negative active material into this cavity, moving said walling to create a second cavity of the second set, inserting an electrode structure into this cavity and introducing positive active material into this second cavity, and repeating the procedure to obtain the requisite number of positive and negative battery plates.

According to an eleventh aspect of the present invention there is provided a method of manufacturing an electrical storage battery which comprises providing walling which bounds open topped spaces, inserting an electrically conductive electrode structure into each space, and introducing electrochemically active positive material into some of said spaces and electrochemically active negative material into intervening spaces so as to embed the electrode structures in said material.

This method can comprise inserting at least two electrically isolated, electrically conductive electrodes into one or more of the spaces.

The method can also comprise using sheet material to form said spaces and placing a rectilinear electrodes structure in each of said spaces. In a modified form of the method the electrode structure is placed adjacent a first sheet and a second sheet is placed adjacent said electrode structure to bound said space.

According to a twelfth aspect of the present invention there is provided a method of manufacturing an electrical storage battery which comprises placing a smaller diameter pipe within a larger diameter pipe to form walling, placing a cylindrical electrode structure in the annular space between said pipes, and introducing electrochemically active material into said space.

It is possible to secure a plurality of vertical electrodes to upper and lower electrode elements to form an electrode structure.

A plurality of strings or rods which span between the upper and lower electrode elements can be provided, said strings or rods being embedded in the active material and being withdrawn from the active material to leave bores in the active material.

Said electrodes are preferably extruded and are of non-circular cross section.

The electrodes can be extruded leaving cavities in them so that they are hollow. The method can also comprise encasing an electrically conductive core inside a protective sheath of lead to produce an electrode.

### BRIEF DESCRIPTION OF THE SEVERAL VIEWS OF THE DRAWINGS

For a better understanding of the present invention, and to show how the same may be carried into effect, reference will now be made, by way of example, to the accompanying drawings in which:—

FIG. 1 is a pictorial view of a positive battery plate;

FIG. 2 is a top plan view of the plate of FIG. 1;

FIG. 3 is a top plan view of a cylindrical battery in accordance with the present invention;

FIG. 4 illustrates an electrode assembly;

FIGS. 5, 6, 7, 8 and 9 are pictorial views of electrode components;

FIGS. 10 and 11 are plan views illustrating battery configurations;

FIG. 12 illustrates a segment of a cylindrical battery which includes electrodes of the form shown in FIG. 5;

FIG. 13 is a pictorial view of a further battery in accordance with the present invention;

FIG. 14 is a top plan view of the battery of FIG. 13;

FIG. 15 is a pictorial view of an electrode;

FIG. 16 is a pictorial view of a tube forming part of the electrode of FIG. 15;

FIG. 17 is a pictorial view of a mould with the tube of FIG. 16 therein;

FIGS. 18 and 19 are pictorial views of void formers;

FIG. 20 is a pictorial view illustrating a step in the manufacture of the battery;

FIG. 21 is a top plan view of the structure shown in FIG. 20;

FIGS. 22 and 23 are similar to FIGS. 20 and 21 and shown the configuration after the casing has been filled with negative electrochemically active material;

FIGS. 24 and 25 are similar to FIGS. 22 and 23 and show the next stage in the manufacture of the battery; and

FIGS. 26, 27, 28, 29 and 30 show further possible battery configurations;

FIG. 31 is a pictorial view of the upper end of an electrode;

FIG. 32 is a pictorial view of a bus bar;

FIG. 33 is a pictorial view of the upper end of a battery in accordance with the present invention with the casing omitted;

FIG. 34 is a vertical section through the upper part of the battery shown in FIG. 33; and

FIG. 35 is a pictorial view of a further electrode.

### DESCRIPTION OF SPECIFIC EMBODIMENTS OF THE INVENTION

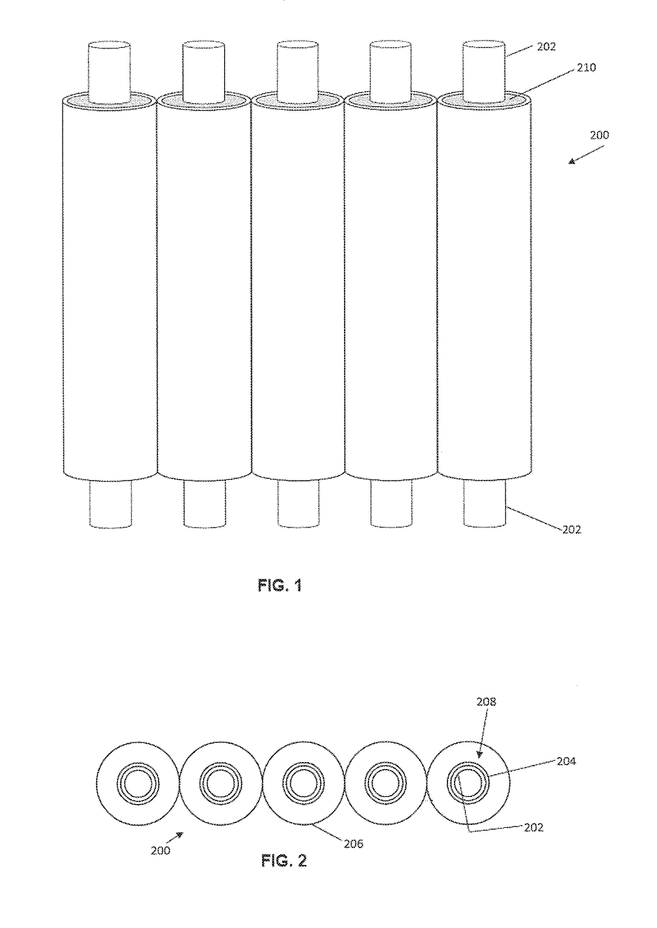

The tubular positive battery plate 200 shown in FIGS. 1 and 2 comprises electrically conductive metal cores 202 of, for example, aluminium or copper. The cores 202 are shown as being of circular cross section but can be rectangular, including square, or of another shape. Commercially available aluminium or copper tubes can be used as the cores.

Each core is coated with a layer 204 of lead to protect it from the battery acid. The lead is preferably thermally sprayed onto the cores.

The cores pass through a gauntlet 206 which is of a porous material configured to provide, in the illustrated form, a row of five discrete tubular cavities 208 through which the cores 202 pass.

Caps 210 are fitted into the upper and lower ends of the cavities 208 to close them off. A resin is used to secure the caps in place and to seal between the caps and the gauntlet.

Access openings (not shown) in the upper caps 210 enable a slurry of electrochemically active positive material to be fed into the cavities 208. Resin is used to close the access openings when filling is complete.

It is well known that positive active material, when subjected to charging and discharging cycles, tends to disintegrate. When the plate shown in FIGS. 1 and 2 is placed in an acid filled casing, the gauntlet remains in place to inhibit such disintegration.

As negative active material is more resistant to degradation, negative plates can be produced as described with reference to FIGS. 1 and 2 but using removable moulds. Once the negative active material has set the moulds are removed. Negative plates produced in this way are placed in an acid-filled casing alongside the positive plates described above with separators between them. Appropriate electrical connections are made to the cores.

The battery 10 illustrated in FIG. 3 comprises an outer casing 12 which can be a length of pipe extruded using an acid resistant synthetic plastics material. The battery has an inner sleeve 14 which can also comprise a length of pipe. This pipe can be formed with a multitude of small holes and the central cavity designated 16 can be filled with electrolyte. Alternatively, the pipe 14 can form a barrier between the central cavity 16 and the electrolyte which is confined between the casing 12 and the pipe 14. The cavity 16 can in this alternative form have coolant circulated through it to carry away the heat generated during operation.

References 18, 20, 22, 24, 26 and 28 all designate cylindrical separators between the electrochemically active materials which are in the form of concentric cylinders. Reference numerals 30, 32, 34 and 36 designate electrochemically negative cylinders and reference numerals 38, 40 and 42 designate the intervening cylinders of electrochemically positive material.

The separators are of thin material which, whilst capable of preventing direct contact between the negative and positive material, is porous with respect to the electrolyte.

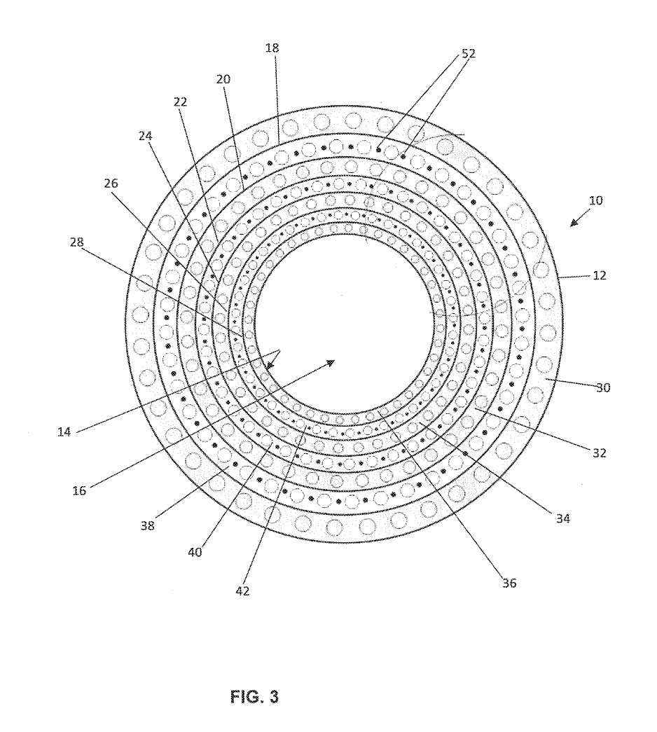

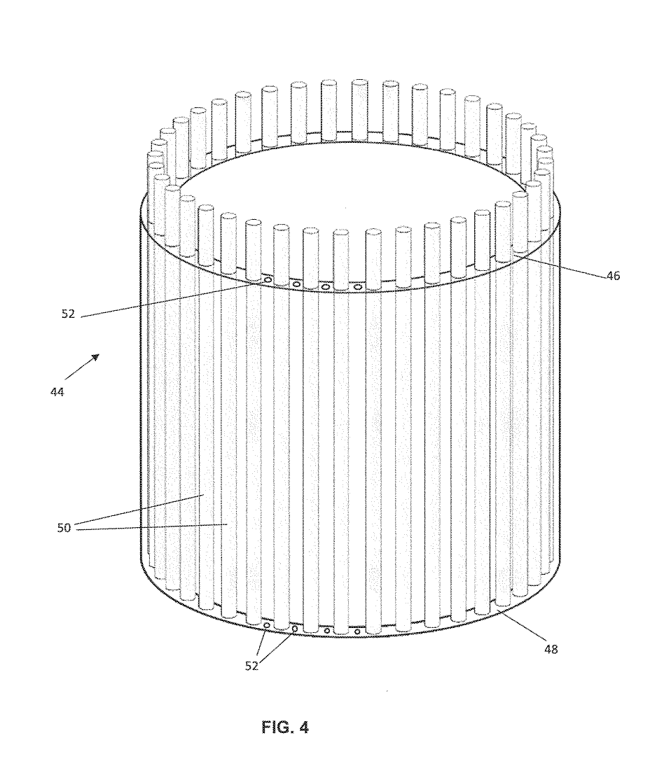

Each cylinder of electrochemically active material has an electrode structure 44 embedded in it. The electrode structures 44 are of the form shown in FIG. 4.

Each electrode structure comprises an upper ring 46, a lower ring 48 and bars 50 spanning between the upper and lower rings. The number of bars in the electrode structures vary. The radially outer electrode structures have more bars than the radially inner ones.

The rings 46 and 48 have small holes 52 in them which alternate with the locations at which the bars 50 are connected to the rings 46 and 48.

Flexible strings or solid rods of polypropylene or another material that electrochemically active paste will not adhere to are passed through the holes 52 and span between the upper and lower rings of the structure 44.

Manufacture of the cylindrical battery proceeds as follows. Former pipes (not shown) are placed co-axially within the pipe which constitutes the outer casing 12. The gaps between the pipes, measured radially, are equal to the requisite thickness of the cylindrical plates to be formed. These former pipes create the positive active material cavities for the cylinders 38, 40 and 42. An electrode structure as shown in FIG. 4 is lowered into each space.

The cylindrical separators 18, 20, 22, 24, 26 and 28 are slid in between the electrodes and the former pipes or are placed around the former pipes before they are placed in the outer casing. Alternatively the cylindrical separators are slid into the former pipes into which positive active material will be poured.

Electrochemically positive active material in the form of a flowable paste is then poured into the cylindrical cavities between co-axially arranged former pipes. The positive electrode structures are embedded in the positive active material, creating the positive plates.

The paste is permitted to dry either naturally or drying is accelerated by the application of heat. Once the paste has set sufficiently to be self-supporting, the former pipes are lifted out of the casing 12 to leave the positive cylinders 38, 40 and 42 with their associated embedded electrode structures.

The inner sleeve 14 is then slid into place and hence there are now four cylindrical cavities which are to become the negative cylindrical plates.

The negative electrode structures are slid into the four cylindrical cavities. Negative electrochemically active material in the form of a flowable paste is used to fill these cavities and form the negative cylinders 30, 32, 34 and 36.

The strings or rods spanning between the rings 46, 48 are also embedded in the paste. At this stage they are pulled out of the paste thereby to provide fine bores which extend from top to bottom of the paste and which are eventually filled with electrolyte.

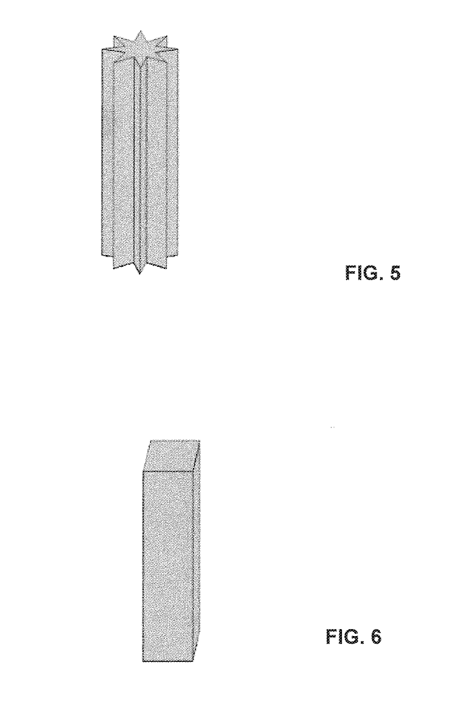

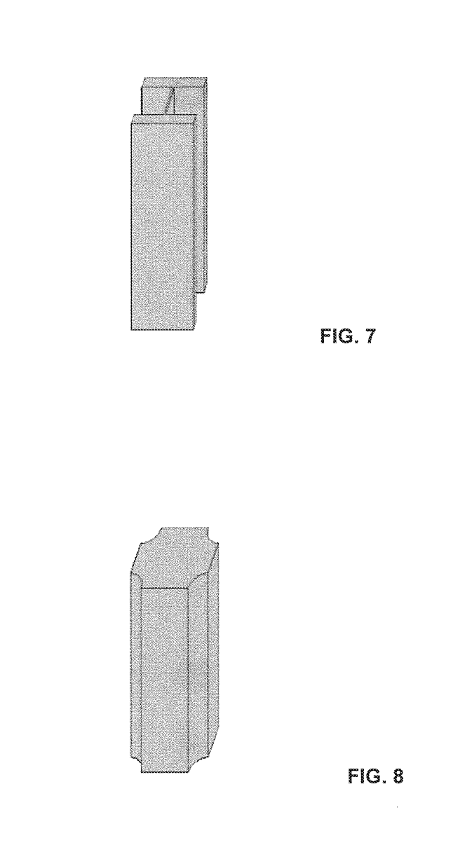

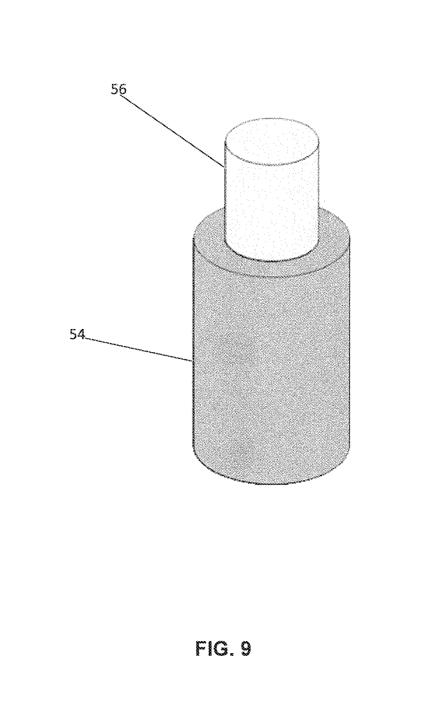

In FIG. 4 the vertical bars of the electrode structure are shown as being circular in cross section. FIGS. 5, 6, 7 and 8 show electrode bars which are of non-circular cross-section. FIG. 9 is drawn to a larger scale than FIGS. 5, 6, 7 and 8 and illustrates a cylindrical electrode bar which comprises a sheath 54 of lead and a core 56 which is of a material such as copper or aluminium which is more electrically conductive than lead. The lead protects the copper or aluminium from corrosion by the electrolyte and the core material enables the internal resistance of the battery to be reduced.

The electrodes of FIGS. 5, 6, 7 and 8 can each comprise a lead sheath and a central core of copper or other electrically conductive material. Alternatively the electrodes can be hollow to reduce weight and enhance cooling as described above with reference to FIGS. 1 and 2.

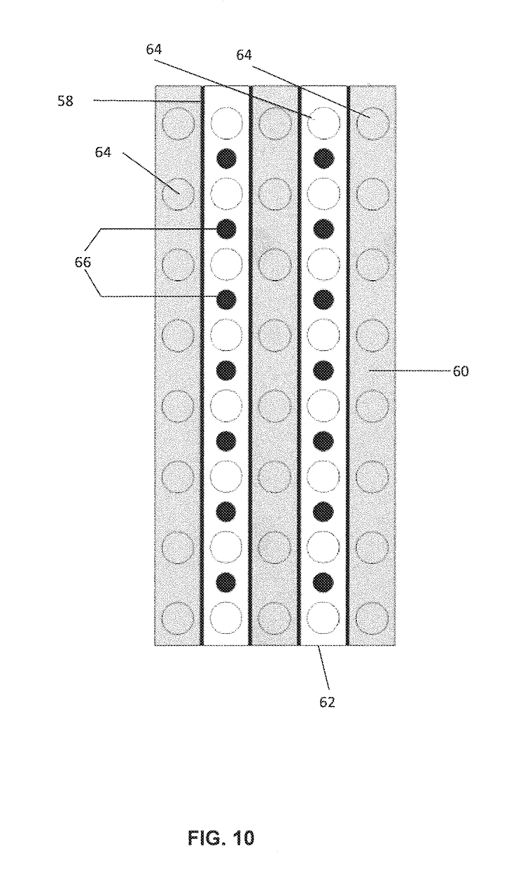

In FIG. 10 the plates are cast between planar walls as opposed to the cylindrical formers used to produce the plates of FIG. 3. The electrode structure in this form is rectangular rather than cylindrical but is otherwise of the same construction. The rings 46, 48 are replaced by straight top and bottom plates.

A flat separator 58 is placed against the exposed face of the negative plate 60 after the paste has set and one of the two walls has been removed. The wall is then placed adjacent, but spaced from, the separator 58 to form another gap and paste of the opposite polarity is fed in to form the first positive plate 62. This procedure continues until all the requisite plates have been cast. An alternative procedure is analogous to that described above with reference to FIG. 3 and comprises erecting a plurality of spaced walls which provide spaces for the positive electrode structures and electrochemically positive material. After the positive paste has set sufficiently to be self-supporting, all the walls are lifted out to provide spaces for the negative electrode structures, the separators and the electrochemically negative paste.

In FIG. 10 the vertical bars of the electrode structure are designated 64. The strings which span between the top and bottom bars are referenced 66.

In FIG. 11 the electrode bars 68 are hexagonal and the forming walls have alternating ribs and grooves. This leaves gaps of the form illustrated which are filled with electrochemically active paste. The negative plates are designated 70 and the positive plate between them is designated 72.

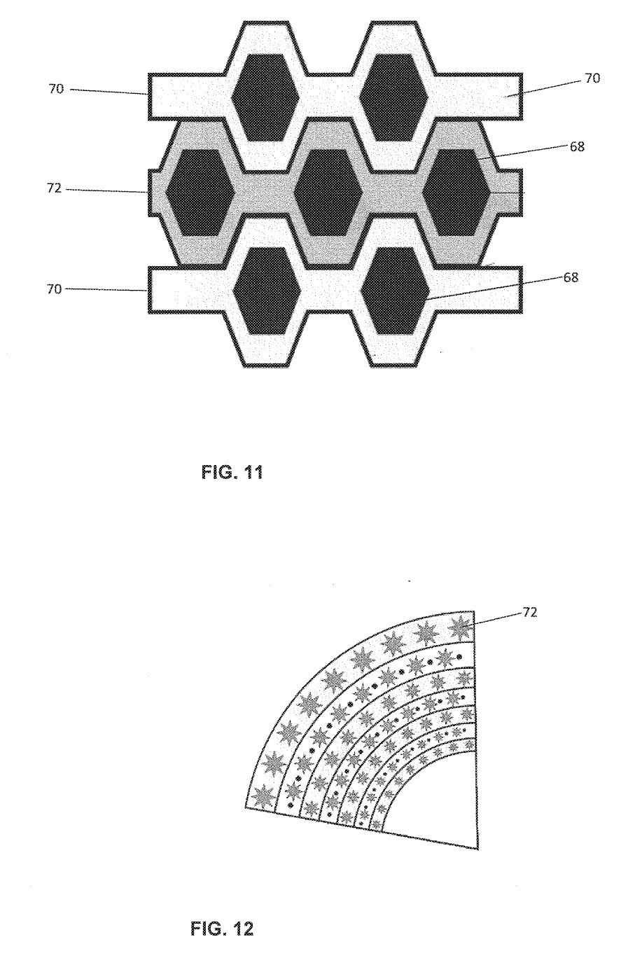

In FIG. 12 there is shown a segment of a cylindrical battery which has electrode bars 72 of the form shown in FIG. 5.

The procedure described above provides methods of manufacturing electrical storage batteries which obviates the disadvantages of current manufacturing techniques and enables the manufacturing of utility scale accumulators. An accumulator manufactured in accordance with the described procedure has a significantly reduced cost with an increased life expectancy and charge acceptance as compared to batteries manufactured by conventional methods. The manufacturing procedure described requires less specialised equipment.

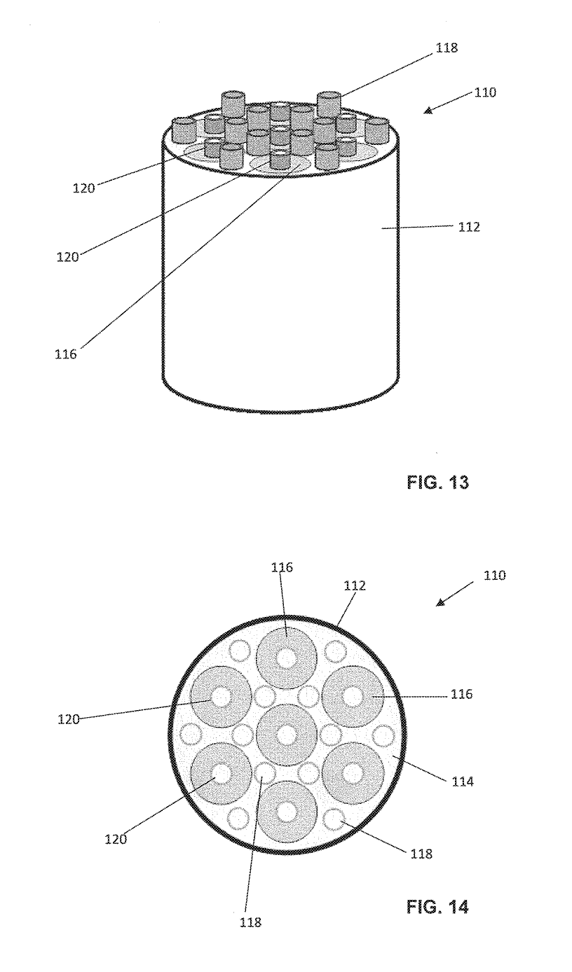

The battery shown in FIGS. 13 and 14 is designated 110 and comprises an outer casing 112 constituted by a length of pipe extruded using an acid resistant synthetic plastics material. The casing is closed at its lower end by a disc-like base which is not visible in FIGS. 13 and 14.

Within the casing there is electrochemically negative material 114 which constitutes, when the battery has charge in it, a source of electrons. Also in the casing is electrochemically positive material 116 which can receive and absorb electrons during discharge of the battery.

Negative terminal posts 118 protrude upwards from the negative material 114 and positive terminal posts 120 protrude upwards from the positive material 116. The posts all project upwards above beyond the upper edge of the casing 112. A closure (not shown) through which the terminal posts protrude closes the upper end of the casing 112. Seals (not shown) encircle the posts and prevent battery acid in the casing leaking out between the posts and the closure.

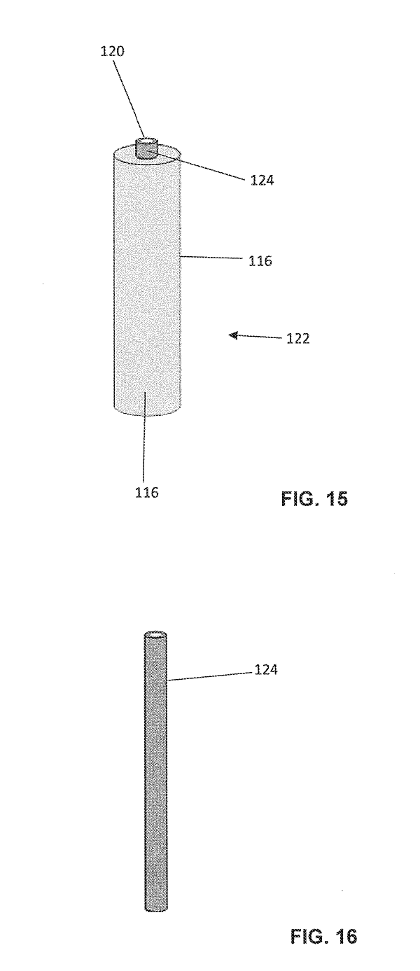

One of the electrodes of the battery will now be described with reference to FIGS. 15 and 16 and the method of manufacture of the battery will subsequently be explained.

The electrode 122 shown in FIG. 15 includes a core which is in the form of a tube 124 which is open at both ends. The tube can be of copper or steel, including stainless steel, or of a conductive polymer but is preferably of aluminium. The tube 24 is sheathed in a thin layer of lead to protect the tube from corrosion by the battery acid. The form of electrode which incorporates an aluminium tube will be described.

The positive material 116 of the battery is in the form of a cylinder which is cast, as will be described, around the lead sheathed aluminium tube 124. The lead sheathed tube 124 projects from the upper end of the material 116 and constitutes one of the positive terminal posts 120. A number of electrodes 122 are used in the construction of the battery.

The positive electrode is manufactured by first removing any oxide layer which has formed on the outer surface of the aluminium tube 124. This can be achieved chemically or by sand blasting. The tube is then hot dipped in a lead bath, so that the cylindrical, external surface of the tube is covered by a protective sheath of lead. The tube can be tinned before the dipping to improve adhesion between the tube and the lead sheath. It is also possible to extrude the lead coating onto a core of aluminium, or to thermally spray the lead on or to use a wavesoldering machine.

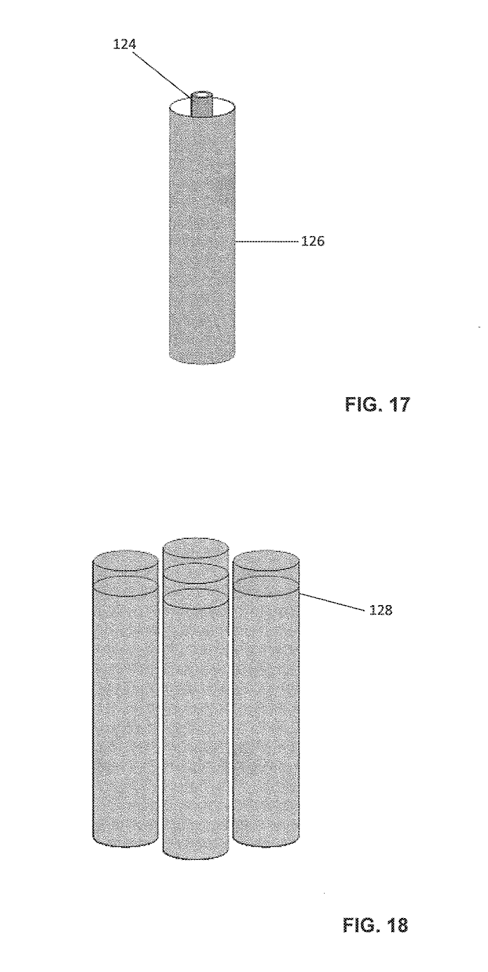

The lead sheathed tube 124 is placed in a cylindrical mould 126 as shown in FIG. 17. The mould 126 can be in the form of a gauntlet. A slurry of positive electrochemically active material is then poured into the mould 126. The material is dried to drive off the liquid content and, if necessary, is hydroformed. The resultant electrode 122 is then slid out of the mould 26 if the mould is of non-porous material but can be left in the mould if it is in the form of a gauntlet.

A thin porous separator of any conventionally used material (not shown) is wrapped around the electrode 122.

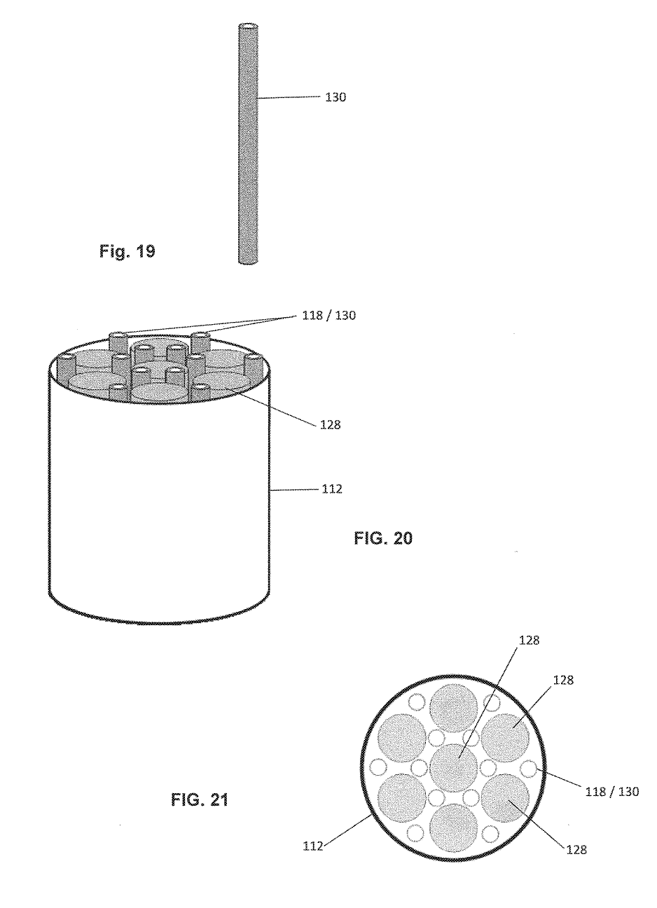

The battery is manufactured by placing removable cylindrical void formers 128 (FIG. 18) and lead sheathed elements 130 (FIG. 19) in the casing 112. Only one element 130 is shown in FIG. 19 but, as will be seen from FIGS. 20 and 21, a number are used. The void formers 128 and elements 130 can be tubes or can be solid rods. As shown by way of example in FIGS. 20 and 21, the elements 130 are tubes and the void formers 128 are solid rods. The upper parts of the elements 130 constitute the negative posts 118 of the battery.

The formers 128 and elements 130 can be arranged in any desired pattern. FIG. 21 shows an array which is particularly suitable for use in the cylindrical casing 112. The void formers 128 are in a circular array and there is also a centrally positioned one. The elements 130 are in two circular arrays. Those elements 130 in the outer array alternate with the void formers 128 and those in the inner array encircle the centrally positioned void former 128.

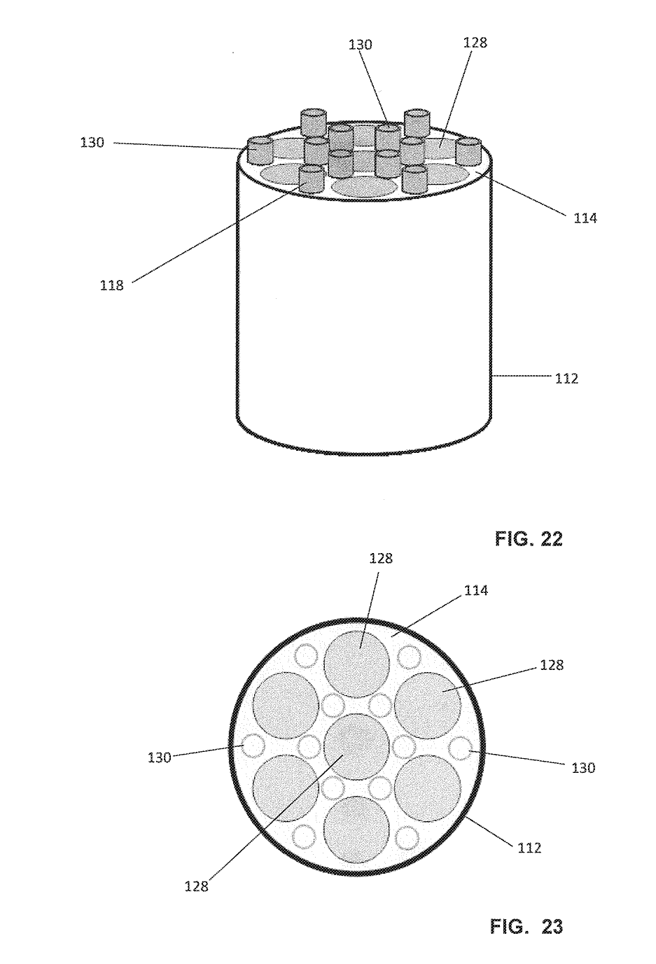

A slurry of negative electrochemically active material is then poured in to fill that volume of the casing 112 which is not occupied by the void formers 28 and elements 30 (see FIGS. 22 and 23). The resultant body of negative material embeds and adheres to the elements 130. It will be seen from FIG. 23 that the elements 130 protrude above the level of the top edge of the casing 112 and, as mentioned, in the manufactured battery, the upwardly projecting parts of the elements 130 constitute the negative terminals posts 118.

The slurry is then allowed to cure naturally, or curing can be accelerated by the application of heat. The slurry can be hydroset by subjecting it to humidity and heat if this is required.

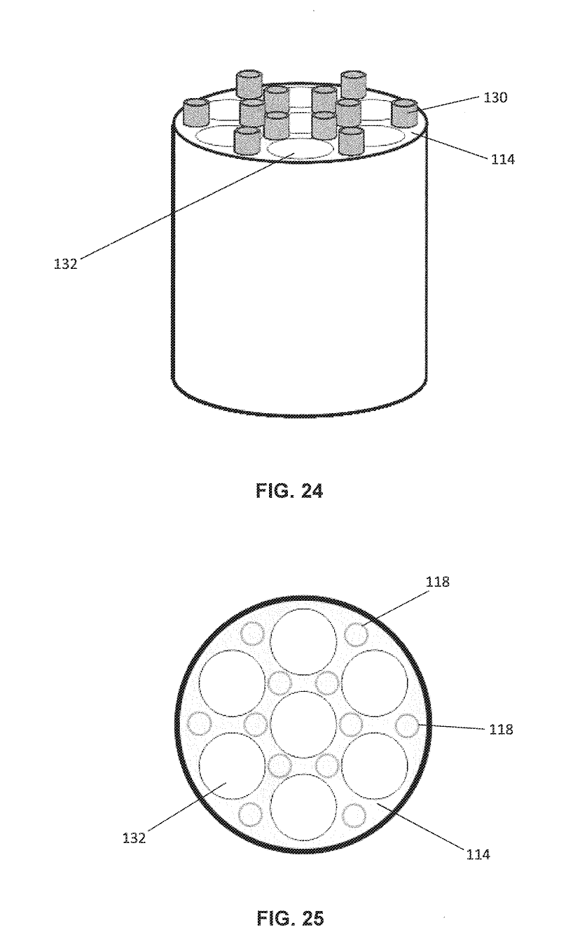

The void formers 128 are then removed (see FIGS. 24 and 25) to leave cylindrical voids 132. The elements 130 remain in place embedded in the negative material 114.

Electrodes 122 of the form illustrated in FIG. 17, with porous separators wrapped around them, are then slid into the voids 132, the casing is filled with battery acid and the top closure fitted.

The tubes 124 can, in a specific form of the battery, pass in a leak proof manner through the base of the casing 112. Coolant (air or liquid) can be pumped through the tube to carry away heat and enable temperature increases to be avoided. Alternatively, heat can be carried away by convection, air simply being allowed to rise in the tubes 124.

It is also possible for the elements 130, when these are hollow tubes, to pass through the base of the casing in a leak proof manner, and to be used for cooling in the same way of the tubes 124 are.

If the battery is being used in conditions where it may be cooled below the optimum operating temperature, heated fluid, gaseous or liquid, can be fed through the tubes 124 and elements 110.

It is well known in the art that the positive electrodes erode whereas erosion of the negative electrodes is minimal. The construction described enables eroded positive electrodes readily to be replaced without the necessity of replacing the negative electrochemically active material or the elements 130.

In the above, with reference to FIGS. 15 and 16, the manufacture of the positive electrodes of the battery has been described. It is also possible to manufacture the negative anodes in an analogous manner by casting a tube or rod into a negative electrochemically active material. In this form it is positive material that is used to fill the spaces around the formers 128 and elements 130 (see FIG. 23).

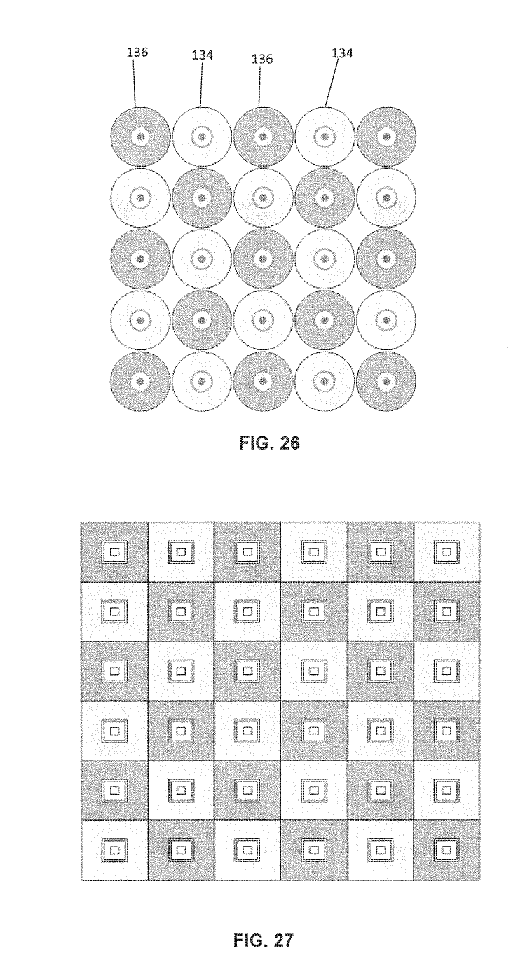

In FIG. 26 cylindrical positive electrodes 134 and cylindrical negative electrodes 136 produced as described with reference to FIGS. 15, 16 and 17 are shown in an array where cylindrical negative and positive electrodes alternate. There are separators in the form of sleeves which sheath either the positive or the negative electrodes to prevent direct contact. The array is in a casing (not shown) and the voids between electrodes will normally be filled with battery acid. However, it is possible to fill the voids with a slurry of a negative material containing activated carbon and/or fumed silicia. The positive electrodes are sheathed using porous polyethylene or an absorbent glass mat to prevent contact between the positive and negative material. If the slurry is of positive material then it is the negative electrodes which are sheathed to prevent direct contact between the negative and positive materials.

In FIG. 27 the electrodes have all been cast in square section moulds and placed in an array with positive and negative electrodes alternating. Separators prevent direct contact between the positive and negative electrodes.

To promote contact between the battery acid and the active material it is possible to provide fine rods, fine tubes or strings in the mould in which cylindrical electrodes are cast and also in the casing 112 between the formers 128 and elements 130. These are pulled out after the active material has set and the passages that remain fill with battery acid.

The current conductors constituted by the tubes 124 and the elements 130 ensure that the full vertical extents of the bodies of active material take part in the electrochemical reactions.

The terminals posts 118 can have bus bars clamped to them which connect the positive terminal posts to one another in any desired grouping. Likewise, the negative terminals posts 120 can be connected in any required grouping.

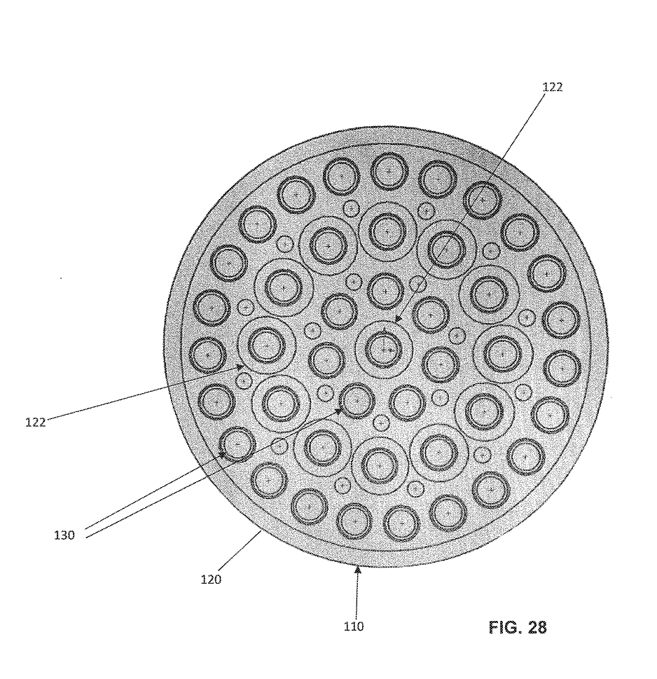

In FIG. 28 the electrodes 122 and negative elements 130 are arranged in concentric circular arrays. The radially outermost array and the radially innermost array both comprise negative elements 130 and the intermediate array comprises electrodes 122. There is a central electrode 122.

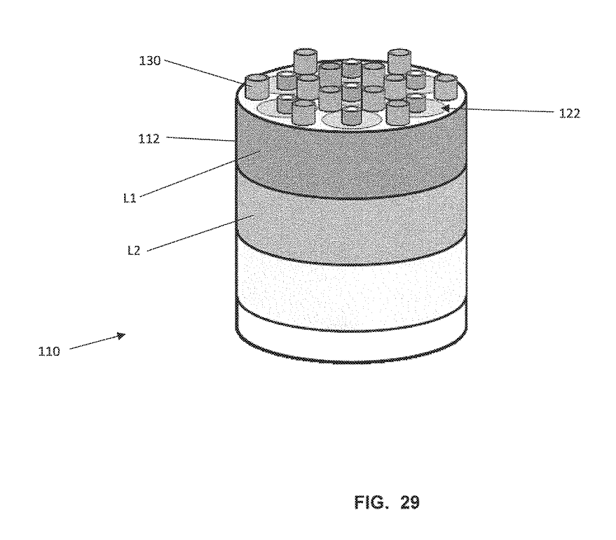

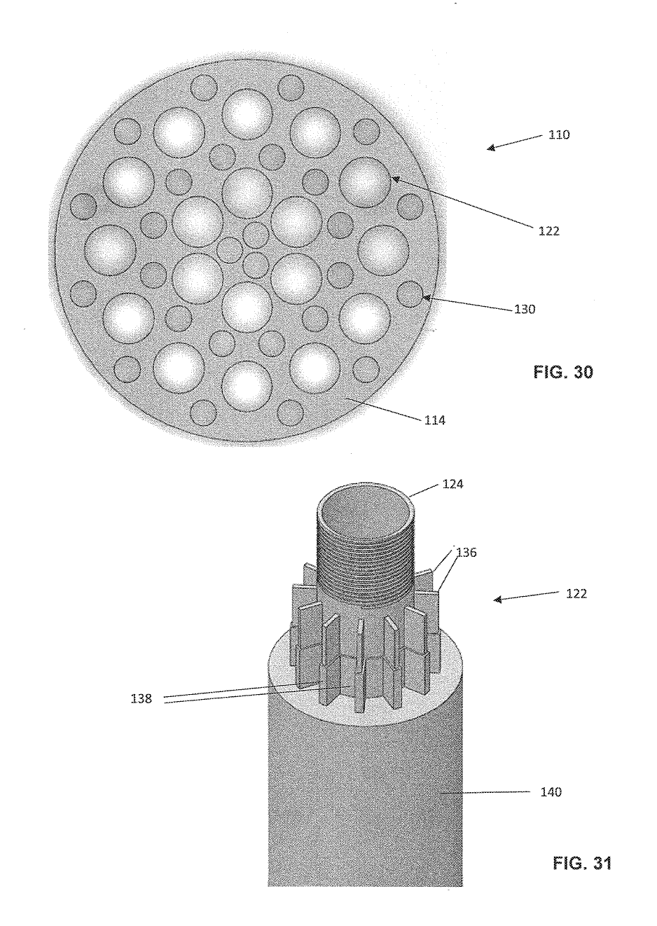

The battery of FIG. 29 differs from the battery of FIG. 28 only in that the positive electrodes 122 and the elements 130 are arranged in a different pattern. The passages which fill with battery acid have not been illustrated in this Figure.

Whilst the slurry can comprise a single type of active material it is also possible to pour in, in succession, different types of active material to form a plurality of active material layers L1, L2 etc. as shown in FIG. 29.

Turning now to FIG. 31, this illustrates the upper end of the electrode 122. The tube 124 constituting the electrodes is finned, the fins being designated 136. The tube has a lead sheath 138 which encases not only the cylindrical part of the tube but also the fins 136. The cast electrochemically active material, which will usually be positive but could be negative, is designated 140. The upper section of the tube 124 is, as illustrated, externally threaded.

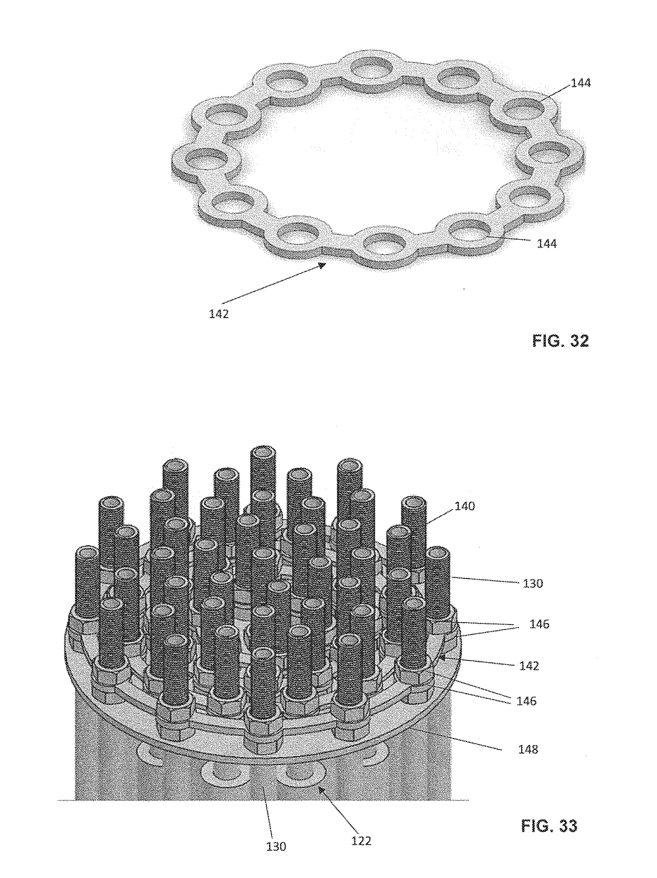

A bus bar 142 is shown in FIG. 32, the bus bar being in the form of a ring with holes 144 in it.

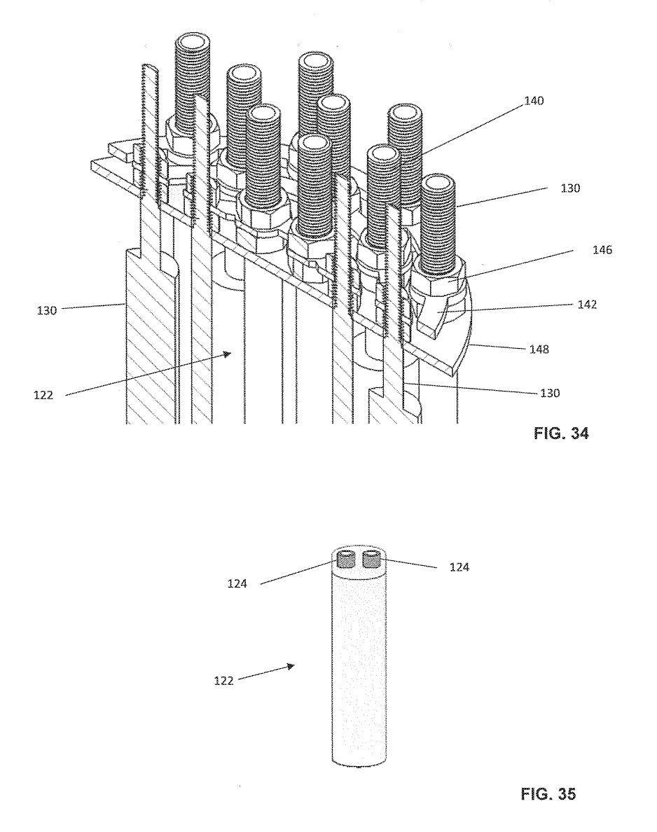

As shown in FIGS. 33 and 34, the electrodes 122 and elements 130 are in circular arrays. The electrodes 122 and elements 130 in each array are electrically connected to one another by bus bars of commensurate diameter and with an appropriate number of holes in it. Nuts 146 above and below the bus bars tightened onto the threaded sections of the tubes 124 ensure that the requisite electrical connections between the bus bars 142 and the tubes 124 are made. It is noted that the top section of each element 130 is also threaded and that the elements 130 are electrically connected by bus bars 142 of appropriate diameter.

In FIG. 34, whilst the cylindrical casing 112 has been omitted, the cover through which the electrodes 122 and elements 130 protrude has been illustrated and is designated 148.

It is also possible for each electrode 122 to comprise two parallel spaced tubes which are embedded in the active material. In this form each positive electrode has two terminals. An electrode of this form is illustrated in FIG. 35.

What is claimed is:

1. An electrical storage battery electrode comprising an electrically conductive elongate metal core which is sheathed in lead to protect the core from corrosion by battery acid.

2. An electrode as claimed in claim 1, wherein the core is tubular.

3. An electrode as claimed in claim 2, wherein the core comprises a copper or aluminium tube.

4. An electrode as claimed in claim 1, wherein the core has external fins.

5. An electrode as claimed in claim 1, wherein the outer surface of the core is of non-circular configuration.

6. An electrical storage battery having an electrode which is in the form of a tube which is open at its upper and lower ends.

7. A battery as claimed in claim 6, wherein said electrode comprises an elongate metal core which is sheathed in lead to protect the core from corrosion by battery acid.

8. A battery as claimed in claim 6 and having positive electrodes and negative electrodes each of which is in the form of a tube which is open at its upper and lower ends.

9. A method of manufacturing a cast battery plate for an electrical storage battery which comprises placing an electrically conductive electrode in a mould, feeding a slurry of electrochemically active material into the mould so as embed the greater part of the element in the material whilst leaving a portion protruding from the material so as to provide a terminal post, and removing the plate from the mould after the active material has dried sufficiently to be self-supporting.

10. A method of manufacturing a cast positive battery plate for an electrical storage battery which comprises placing an electrically conductive electrode in a mould the walling of which is porous, feeding a slurry of electrochemically active positive material into the mould so as to embed the greater part of the electrode in the active material whilst leaving a portion protruding from the material to form a terminal post.

11. A battery comprising a first set of cast plates manufactured by placing an electrically conductive electrode in a mould the walling of which is porous, feeding a slurry of electrochemically active positive material into the mould so as to embed the greater part of the electrode in the active material whilst leaving a portion protruding from the material to form a terminal post and a second set of cast plates manufactured by placing an electrically conductive electrode in a mould, feeding a slurry of electrochemically active negative material into the mould so as embed the greater part of the element in the material whilst leaving a portion protruding from the material so as to provide a terminal post, and removing the plate from the mould after the active negative material has dried sufficiently to be self-supporting, the sets of plates being immersed in battery acid.

12. A battery as claimed in claim 11, wherein said electrodes are elongate tubes which protrude from the active material in both directions so as to provide fluid flow paths through the battery.

13. A battery as claimed in claim 11, wherein each electrode comprises an electrically conductive metal core which is lead coated.

14. A method of manufacturing an electrical storage battery which comprises placing electrically conductive electrodes and void formers in a casing, feeding electrochemically active material into the casing to embed the formers and the electrodes in the material, removing the void formers from the material and inserting electrodes manufactured as claimed in claim 10 into the voids that remain upon removal of the void formers.

15. An electrical storage battery comprising a vertically elongate casing, a plurality of spaced apart elongate battery plates extending vertically within the casing, each plate comprising an electrically conductive core which is sheathed in lead to protect it from corrosion by the battery acid and a body of electrochemically active material moulded onto the core, the space in the casing around the electrodes being filled with electrochemically active material of opposite polarity, electrically conductive elements protruding from the active material which fills said space and porous separators between the active material of the plates and the active material filling said space.

16. A battery as claimed in claim 15, wherein said electrodes are arranged in one or more circular arrays.

17. A battery as claimed in claim 16, wherein said elements are arranged in one or more circular arrays, arrays of electrodes alternating with arrays of elements.

18. A battery as claimed in claim 15, wherein the moulded material of the core is electrochemically active positive material.

19. A method of manufacturing an electrical storage battery which comprises manufacturing plates by moulding electrochemically active material onto electrically conductive cores which are sheathed in lead, placing elongate void formers and elongate electrically conductive elements in an elongate casing, filling the space around said void formers and elements with electrochemically active material of opposite polarity to that of the plates, removing the void formers to provide voids and inserting electrodes into the voids, there being porous separators between the plates and the active material filling said space.

20. A method as claimed in claim 19, wherein electrochemically active materials of different composition are fed into the casing to provide layers having different characteristics.

21. A method as claimed in claim 19 and comprising threading the upper ends of said cores and said elements, using bus bars with holes through which said upper ends project to connect cores to one another and elements to one another, and screwing nuts onto said upper ends to clamp the bars to the respective cores and elements.

22. An electrical storage battery which comprises a casing which has in it a body of electrochemically active material with electrically conductive elements embedded in said body of material but each having a part thereof protruding from the body, and battery plates each comprising a lead sheathed electrically conductive metal core with electrochemically active material cast onto it, the cores protruding from the cast active material, said plates being in voids provided therefor in said body of material, being separated from said body by porous separators, and being removable from said voids.

23. A battery as claimed in claim 22, wherein the cast material is electrochemically positive and the body of material is electrochemically negative.

24. A method of manufacturing an electrical storage battery which method comprises creating a first set of cavities for receiving electrochemically active negative material, creating a second set of intervening cavities for receiving electrochemically active positive material, providing electrically conductive electrode structures in said cavities, introducing said negative active material into the cavities of the first set of cavities and introducing positive active material into the cavities of the second set of cavities.

25. A method as claimed in claim 24 and comprising creating the cavities of the second set by means of walling, introducing positive active material into said cavities of the second set, removing the walling to leave spaces which constitute the cavities of the first set of cavities, and filling the cavities of the first set with negative active material.

26. A method as claimed in claim 24 and comprising creating a first cavity of the second set by means of walling and inserting an electrode structure into this first cavity, introducing positive active material into said first cavity, moving said walling to create a first cavity of the first set and inserting an electrode structure into this cavity, introducing negative active material into this cavity, moving said walling to create a second cavity of the second set, inserting an electrode structure into this cavity and introducing positive active material into this second cavity, and repeating the procedure to obtain the requisite number of positive and negative battery plates.

27. A method of manufacturing an electrical storage battery which comprises providing walling which bounds open topped spaces, inserting an electrically conductive electrode structure into each space, and introducing electrochemically active positive material into some of said spaces and electrochemically active negative material into intervening spaces so as to embed the electrode structures in said material.

28. A method as claimed in claim 27 comprising inserting at least two electrically isolated, electrically conductive electrodes into one or more of the spaces.

29. A method as claimed in claim 27 and comprising using sheet material to form said spaces and placing a rectilinear electrode structure in each of said spaces.

30. A method as claimed in claim 29 with the modification that the electrode structure is placed adjacent a first sheet and a second sheet is placed adjacent said electrode structure to bound said space.

31. A method of manufacturing an electrical storage battery which comprises placing a smaller diameter pipe within a larger diameter pipe to form walling, placing a cylindrical electrode structure in the annular space between said pipes, and introducing electrochemically active material into said space.

32. A method as claimed in claim 24 and including the step of securing a plurality of vertical electrodes to upper and lower electrode elements to form an electrode structure.

33. A method as claimed in claim 31 and including the further step of providing a plurality of strings or rods which span between the upper and lower electrode elements, embedding said strings or rods in the active material, and withdrawing the strings or rods from the active material to leave bores in the active material.

34. A method as claimed in claim 32, wherein said electrodes are extruded and are of non-circular cross section.

35. A method as claimed in claim 34 and comprising extruding the electrodes whilst leaving cavities in the electrodes so that they are hollow.

36. A method as claimed in claim 34 comprising encasing an electrically conductive core inside a protective sheath of lead to produce an electrode.
